(19) United States
(12) Patent Application Publication
(10) Pub. No.: US 2002/0063034 A1
(43) Pub. Date: May 30, 2002

(54) Methods and apparatus for an electronic drop safe

(76) Inventor: Bob M. Dobbins, Villanova, PA (US)

Correspondence Address: PRIEST & GOLDSTEIN PLLC, 529 DOGWOOD DRIVE, CHAPEL HILL, NC, 27516, US

(21) Appl. No.: 09/960,595

(22) Filed: Sep. 21, 2001

Related U.S. Application Data
(60) Provisional application No. 60/234,133, filed on Sep. 21, 2000.

(51) Int. Cl. G07D 7/00

(52) U.S. Cl. 194/302

(57) ABSTRACT

Systems and techniques for providing an improved electronic safe are described. In one aspect, an electronic safe is provided with enhanced security, increased functionality and ease of use. The electronic safe may accept both cash and non-cash deposits, identifying tags and envelopes or folders. A wireless tag may be used to identify the person making deposits. A plurality of electronic safes may be networked together in a wireless local area network. The wireless local area network of electronic safes may be wirelessly networked with an off site host system. In another aspect, an electronic safe is provided with a wireless communications link for communicating with a handheld terminal which may be used to update the electronic safe and initiate the generation of automatic reports. In another aspect, an electronic safe automatically generates reports detailing the operation of the safe. The electronic safe may predict the time when a cassette for storing deposits will be full.

### CROSS-REFERENCE TO RELATED APPLICATION

The present application claims the benefit of U.S. Provisional Application Serial No. 60/234,133 entitled “Methods and Apparatus for an Electronic Drop Safe” and filed Sep. 21, 2000.

### FIELD OF THE INVENTION

The present invention relates generally to improvements in electronic safes. More particularly, the present invention relates to improvements in electronic safes that provide for enhanced security, increased functionality and ease of use.

### BACKGROUND OF THE INVENTION

Many retail businesses commonly have at least one drop safe on site. Particularly in high cash flow transaction businesses, cashiers are required to limit the amount of cash stored in the cash drawers to a predetermined amount. Any excess cash is placed in a secure drop safe to secure the cash from potential theft. These safes are secure and require considerable effort to break into. Many of these safes are rated as secure devices by independent agencies, such as Underwriter's Laboratories, which require rigorous testing to ensure they are not easily broken into. Unfortunately, the use of these drop safes adds to the paperwork required by both the cashiers and the store managers to track information associated with a deposit, such as the amount of money, cashier, shift and day, for example. Furthermore, when the money is to be removed from the drop safe and taken to the bank or other secured location, the manager must collect, count and sort the money. Additionally, the manager must generate the appropriate reports necessary for the effective running of the business. All of these tasks can consume a significant portion of the manager's time and expose the business to potentially large losses resulting from a robbery occurring while the money is being removed from the safe and counted.

A number of electronic drop safe products are also prevalent in high cash flow transaction businesses. These electronic drop safes may have one or more bill acceptors that can determine the denomination of bills as they are inserted into the bill acceptors and store those bills in a cassette inside the drop safe. Such electronic safes may contain a deposit slot to allow envelopes or wrapped checks, bills and stamps to be inserted and stored for later retrieval. The use of electronics and bill acceptors to recognize bills also allows the reporting and tracking of money by cashier, shift and day easier to do automatically. These electronic drop safes reduce the time the manager must spend to do the counting manually, and also reduce the amount of time the money had to be exposed during those times that the money was removed from the safe to be transferred to a bank or other secured location.

The use of these electronic drop safes added a different set of requirements for the cashiers and managers. Generally, each drop required the cashier to enter his or her identification number through a keypad. The identification numbers or hot keys if incorrectly punched cause errors in identifying the source of the deposited funds. If intentionally wrongly entered, the misidentification might be tied to employee theft. Additionally, a considerable amount of data entry was required on the part of the manager to set up the allowed cashier identification numbers and to create end of shift reports, business day reports, and the like. An identification number typically determines the authority given the manager, which if seen by other employees while the manager is entering this identification number will breech security. Collection reports that summarize the totals collected as well as the subtotals by business day, shift, and the like were generated upon collection of the contents.

These prior art safes force the collections from the safes either at a fixed periodic time determined on a daily basis or by an armored car service schedule. Some safes provide a second bill acceptor which is enabled when the first is full, which adds considerable cost to the safe. In many instances, although the electronic safes are programmed to identify and authorize certain cashiers and managers to use the electronic safe, separate apparatus is used to track the time that cashiers, managers, and other employees are working on site.

It is not unusual to have multiple electronic safes in a single location or facility. In some instances, these safes are operated stand-alone with the manager individually programming each and accessing each safe for reports. In many cases these safes are wired to a back room computer to automatically monitor the activity of each of the safes and generate consolidated reports. In these cases, considerable expense has limited the use of the safes due to the expense of setting up the system, including wiring and configuration, the need for a computer in each facility and customized software to allow the use of the electronic safes.

The trend toward increasing security of bill acceptors, and currency itself has moved the suppliers of bill acceptors to allow for ease of updating through the use of reprogrammable memory, such as flash memory, within their products. With the recent update of US $20 bills and more recently US $5 and $10 bills, some bill acceptor manufacturers have provided update modules to allow their bill acceptor products to be updated by downloading the revised firmware directly from their update modules to their bill acceptors. Unfortunately, in the case of electronic safes, access to the bill acceptors requires a collection be made by physically opening the safe, forcing either the store manager or the armored car service to be present. Handling of the collected money forces a change to the normal business activities to allow for the technician to upgrade the bill acceptor at his convenience rather than at the normal collection time.

### SUMMARY OF THE INVENTION

It is an object of the present invention to provide an improved electronic drop safe for receiving cash and non-cash drops.

It is also an object of the present invention to allow most non-cash deposits to be entered through the bill acceptor, and stored along with the cash deposits.

It is another object of the present invention to provide techniques for entering non-bills or non-accepted bills into the bill acceptor along with a tag identifying its credited value.

A further object of the present invention is to provide an approach for entering non-bills or non-accepted bills into the bill acceptor within an envelope or folder designed to deposit the media or act as a tag.

It is another object of the present invention to allow identification of specific cash or non cash deposits physically within the cash acceptor for later accountability even when using third party counting and pickup services.

It is a further object of the present invention to eliminate the need to have cashiers enter their identification information using a keypad, saving time and eliminating errors, and reducing the opportunity for fraud.

It is a further object of the present invention to provide a more secure approach to the setup of the electronic safe parameters as well as to generate reports.

It is still another object of the present invention to provide for the automatic generation of shift reports, business day reports, cashier reports and the like on a programmable time schedule.

It is yet another object of the present invention to provide advanced notice of when the cassette is likely to be full and a pickup or collection needs to be scheduled.

It is a further object of the present invention to provide business analysis inputs allowing the manager to further optimize the business.

It is another object of the present invention to provide methods and apparatus for tracking the times all employees of an establishment are working on site and generating the appropriate reports thereby replacing the an employee time clock or the like.

Another object of the present invention is to provide for a wireless local area network, which requires little setup and no network installation wiring or costs.

Yet another object of the present invention is to provide a single site node to allow wireless communication to an off site host system.

A further object of the present invention is to provide a mechanism to allow the updating of the bill acceptor to allow new currencies, currency updates, or other firmware updates without requiring a collection.

A more complete understanding of the present invention, as well as other features, objects and advantages of the invention, will be apparent from the following detailed description and the accompanying drawings.

### BRIEF DESCRIPTION OF THE DRAWINGS

FIG. 1 is a system diagram showing various aspects of an electronic safe in accordance with the present invention;

FIG. 2 shows exemplary cash and non-cash media for use with an electronic safe in accordance with the present invention;

FIG. 3 illustrates a block diagram of an electronic safe system in accordance with the present invention; and

FIG. 4 shows exemplary report options for use with an electronic safe system in accordance with the present invention.

### DETAILED DESCRIPTION

The present invention now will be described more fully with reference to the accompanying drawings, in which several presently preferred embodiments of the invention are shown. This invention may, however, be embodied in various forms and should not be construed as limited to the embodiments set forth herein. Rather, these embodiments are provided so that this disclosure will be thorough and complete, and will fully convey the scope of the invention to those skilled in the art.

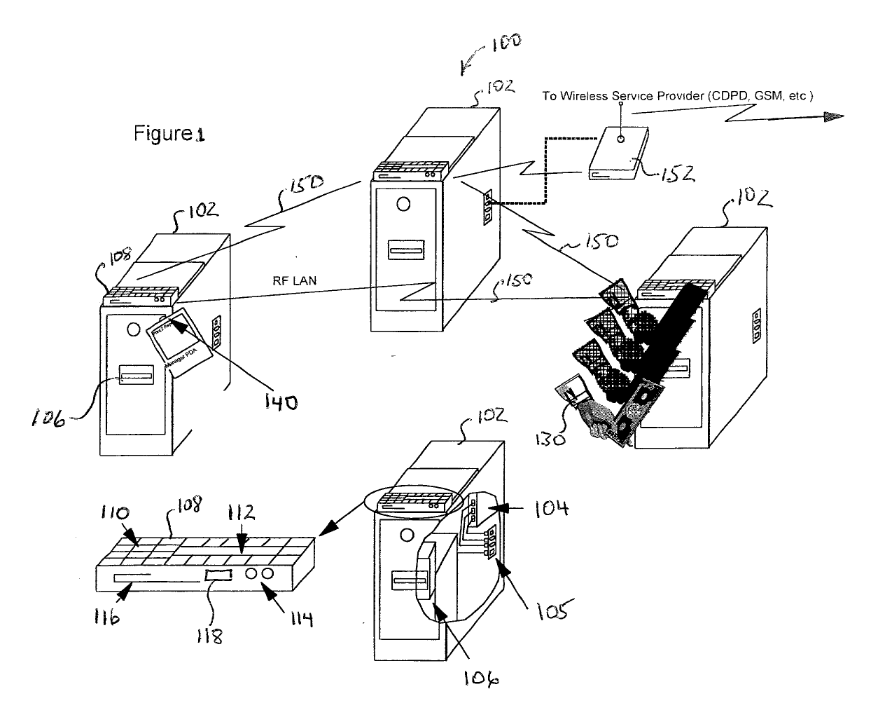

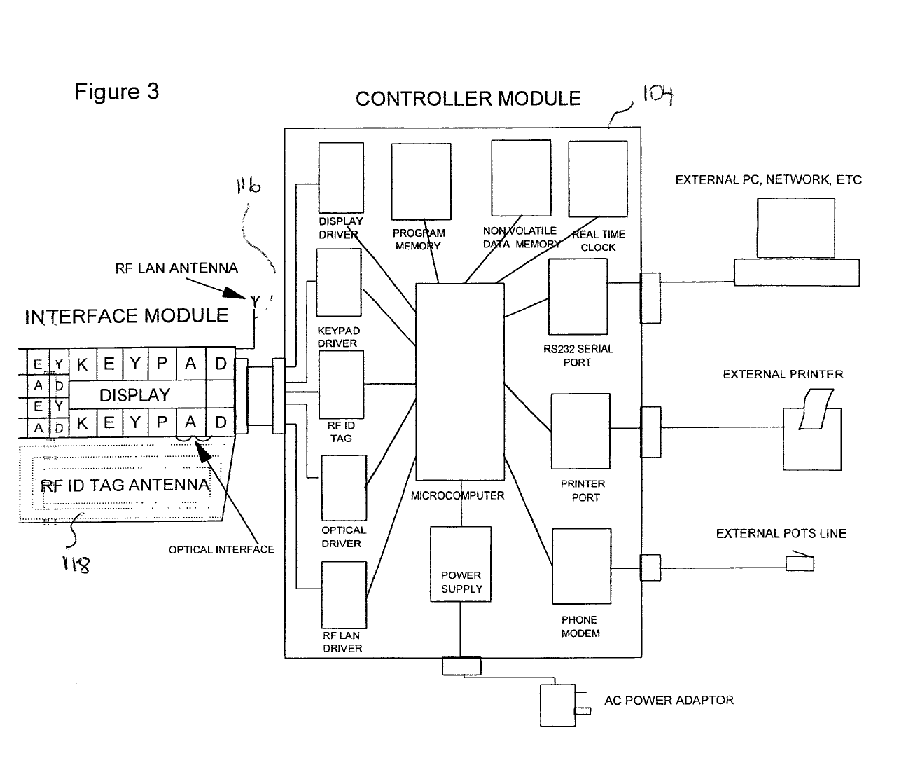

In one aspect, as shown in FIGS. 1 and 3, the present invention provides an electronic safe system 100 comprising a plurality of electronic safes 102. Each electronic safe includes a controller 104 and a bill acceptor 106 for receiving both cash and non-cash deposits. An interface module 108 may include a keypad 110, a display 112, an optical communication port 114, and a radio frequency (RF) local area network (LAN) antenna 116, and an RF identification tag antenna 118. The controller module 104 controls the operation of the electronic safe 102, controls the interface module 108, interfaces with the bill acceptor 106, controls all communications, interfaces with a wireless modem 152, and tracks the operation of the safe 102. External connectors 105 may provide interfaces for power, serial communications, a printer, a phone, and the like. To receive non-cash deposits, the electronic safes 102 accept envelopes or folders utilizing the bill acceptors 106. A check, an unreadable currency note or other item may be placed in the envelope before insertion into the electronic safe 102. Unreadable currency notes are ordinary bills which would not be accepted by the bill acceptor due to wear or damage. The amount of a check or other item may entered through the keypad 110 or transferred directly from a point of sale terminal utilizing a link from the point of sale terminal or backroom terminal.

Other non-cash media can be inserted into the bill acceptor and retained by the electronic safe. This feature dramatically reduces the number of manually handled deposits in most retail establishments. Additionally, a printed or preprinted bill sized information tag can be advantageously used to identify the specific deposited material contained in the envelope. This information tag may be placed in the envelope or inserted into the bill acceptor separately to accompany the envelope. For example, the value of a check or other item contained in an envelope can be printed on the accompanying information tag, allowing the value entered for the bookmarked item to be compared with the accompanying tag to make entry errors easy to find. Alternatively, the value of the check or other item may be printed on the envelope.

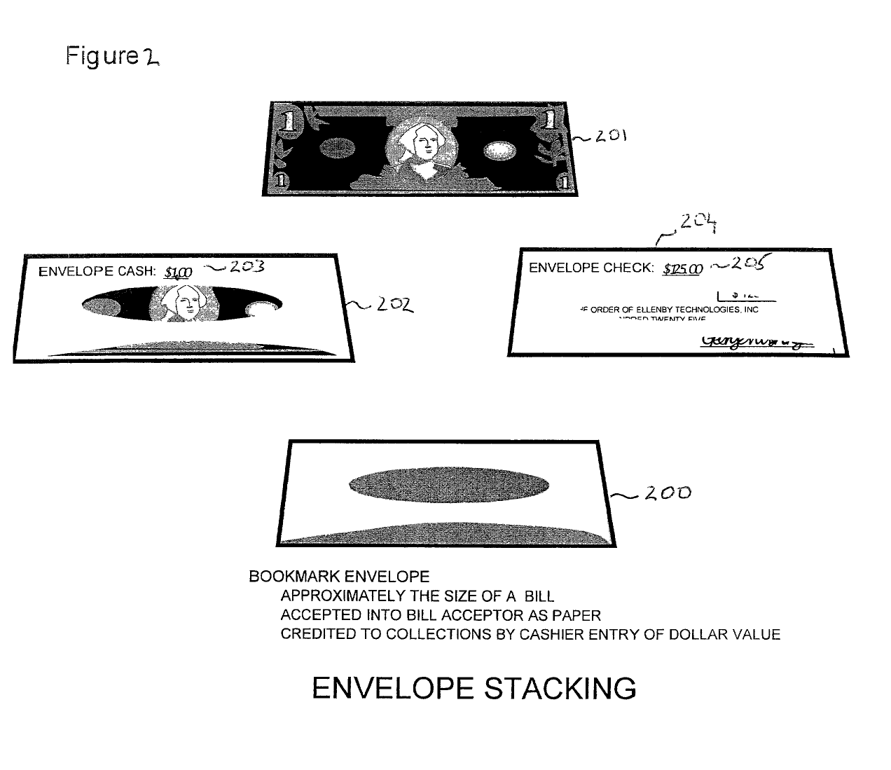

Also, pre-printed identification slips can be inserted into the bill acceptor. Such slips allow a record of the physical identification of cashiers, third party collection agents, manager changeovers, and the like to be stored in the cassette. These preprinted identification slips can be used in combination with envelopes to identify the source of the deposits physically as well as electronically as discussed further below in connection with FIG. 2.

FIG. 2 illustrates an envelope 200 suitable for use in the present invention. The envelope is designed to be approximately the size of a standard currency bill so that the envelope 200 will fit through the entry slot and cassette of a bill acceptor of an electronic safe. As discussed above, an unreadable currency bill, a check or other item may be inserted into the envelope. When a cashier identifies himself or herself to the electronic safe interface module, the controller enables the bill acceptor to expect the envelope and its contents to be deposited. The cashier may enter the value of money to be deposited through a keypad, upon which the controller will allow the cashier to enter whether the value entered is for a rejected bill, a check, a coupon or some other paper item to be deposited. The controller will then enable the bill acceptor to accept the envelope 200. The bill acceptor will accept any paper without attempting to read its value. In one aspect of the present invention, the value of the media contained in the envelope is transferred to the electronic safe directly from a point of sale terminal connected to the electronic safe.

In a preferred embodiment, the bill or other valuable media is entered into the electronic safe using the envelope 200 by placing a bill, such as bill 201, in the envelope to result in a filled envelope 202, as shown in FIG. 2. Alternately, a check may be placed in envelope 200 as seen for filled envelope 204. The amount of the bill 203 or the amount of the check 205 can be printed or handwritten on the envelopes. Alternatively, or additionally, a printed label or receipt including the amount, transaction information, and cashier identification can be generated by the system and placed in the same envelope to fully identify the amount entered and cashier identification. Alternatively, the cashier can have a prenumbered or preidentified envelope to use.

One weakness of current electronic safe products is the requirement that the cashier enter an identification number (ID) through the use of a keypad. In many cases, a single hot key is utilized to enable the bill acceptor in the safe. The identification information is crucial to tracking the amount of cash put into the safe by a given cashier. In the general case in which multiple cashiers are sharing one safe, an error in entering the hot key, or forgetting to enter the ID and depositing bills into the safe before the previous cashier ID has timed out causes errors in the reporting. Insofar as the integrity of the reporting capabilities of such safes is an important timesaving benefit provided by the safes, these easily committed errors are problematic. To ensure the integrity of the collection data, at least some armored car services are providing the collectors with memory keys, which serve to identify them and act as the key to the electronic lock provided on the safe requiring the carrier to position the key within a receptacle to achieve the necessary communication with the electronic safe controller. This option is less practical than a keypad entry for a cashier. The cashier needs to enter his or her ID quickly, which may be accomplished with single key hot keys. The present invention solves the competing requirements of quick ID entry with the need for a reliable secure ID determination through the use of a wireless identification mechanism to provide identification of a person interacting with an electronic safe.

An electronic safe in accordance with the present invention provides a wireless link with a relatively small field of view around the bill acceptor entry slot. Each cashier will have a wireless ID tag, which may be worn like a wristwatch, a name tag or the like. The ID tag will have the cashier's unique identification and will automatically communicate the ID as each bill is inserted. The electronic safe wireless link constantly polls for a cashier or other user and the cashier or other user's wireless link will respond to the poll. This polling arrangement will keep the power requirement within the wireless tag very low, allowing a small replaceable or rechargeable battery to power the tag. However, in a presently preferred embodiment, the transmitter mounted in the safe is used to wirelessly transmit power to the small lightweight radio frequency (RF) ID tag device worn by the cashier, allowing the ID device to operate without a battery.

Persons other than cashiers can be provided with wireless ID tags. For example, the store manager or other authorized personnel can use a wireless ID tag to trigger reports, act as an electronic key similarly to the memory modules described above, or otherwise interact with the electronic safe. Third party collectors can similarly have a wireless ID tag to replace the need for a special key, memory module, or keying in an ID on a keypad at the time a collection is made. The use of keypads to enter the ID of managers, and third party collectors represents a significant security risk as the watchful eyes of unauthorized people could allow improper access to the secure information or the “combination” to the safe. All the technology available to memory keys including changing the ID day to day, restricting use by time of day, making obsolete the ID of personnel who have left the company, and the use of various encryption algorithms to prevent the electronic decoding of codes can be used on wireless ID keys in accordance with the present invention.

This approach eliminates both the errors associated with entering ID's through the keypad and the security risks associated with entering ID's through the keypad while increasing the speed of the drops. Timeouts to end a drop may be instantly overwritten when a different cashier enters a bill into the bill acceptor. FIG. 1 shows an RF ID tag in the form of a bracelet 130. The controller module 104 may house the drive circuitry for the RF ID tag, or it may be external to the controller. The RF identification tag antenna 118 can be mounted in an interface module 108 as shown in FIGS. 1 and 3, or in any other suitable location such as near the bill acceptor 106.

In another aspect, an electronic safe in accordance with the present invention includes an optical communication link. A handheld terminal, such as a personal digital assistant (PDA) 140 of FIG. 1, may be used by the manager to set up the electronic safes and request reports utilizing a wireless optical communications link through a port such as the optical communication port 114 which may suitably be an Infrared Data Association (IRDA) port. This capability allows the manager to have all the functions normally associated with the controller keypad and display, but on a small device that stays with the manager. The manager would use the device 140 with each of the electronic safes and each safe would be programmed with a unique identification number. Further, the device 140 offers the added advantage of providing additional management tools such as calendars, schedules, and the like. The electronic safe includes a secure link, such as an IRDA link, to allow secure communication with the manager's handheld terminal. In the case of identifying a cashier or manager, short-range wireless technology such as optical IRDA, wireless tags, short range IR and the like may be utilized.

In another aspect, as shown in FIG. 1, an electronic safe in accordance with the present invention includes a long range wireless communication link 150 to allow a number of safes 102 in a given store or location to be communicatively connected. A range up to several hundred feet would accommodate most facilities. The local area network of the present invention preferably uses an RF device, such as a Blue Tooth™ transceiver, that achieves this range and is low cost. Each electronic safe may be suitably equipped with a Blue Tooth™, or other RF, transceiver which would allow the safes to communicate to each other or to an RF equipped backroom system. In the absence of a backroom computer, one of the electronic safes can be deemed the master controller and may coordinate all communications including reporting for the site. No wiring is required to network these safes and the technologies used do not require FCC licensing, thus making their use and installation simple.

An electronic safe system in accordance with the present invention will not only allow any number of electronic safes to be networked within a location, but will also allow the network of safes to be monitored remotely. It is known in the prior art to physically wire safes to a backroom computer and through this computer tie to a remote host through a modem. It is also known in the art to have a master electronic safe equipped with a modem and communicate to a remote host directly. As in the local network case, the cost of installing the equipment and running phone lines is high. Further, if phone lines are shared with other equipment, such as point of sale terminals, credit card acceptors, and the like, then access can be limited to all the equipment sharing the line. The present invention solves these problems by accessing a wireless data modem 152 to transfer information between the electronic safes on a site and a host location. A number of commercial services can be used that are very cost effective and do not compete with other resources at the location. Further, by avoiding normal voice channels, higher throughputs can be achieved by the present invention, further minimizing time and costs. Appropriate wireless data modems include CDPD, GSM, and SMS wireless modems.

An electronic safe system in accordance with the present invention may utilize several of these techniques to ensure the widest coverage possible on a national basis. These techniques can further be used to allow the safes access to an Internet IP address. A secure web site would then be used to accumulate the data from electronic safes across the country in the case of large chain stores, allowing for “local” wireless calling at each location, while providing national or international coverage. As seen in FIG. 1, the system 100 shows the interconnection of several electronic safes 102 in accordance with the present invention. Further groups of electronic safes may be additionally connected through the wireless modem 152 to allow even broader coverage.

A system in accordance with the present invention accommodates a number of techniques to optimize its use as appropriate for each customer's requirements. Each of these techniques seeks to minimize the cashier's or manager's time, significantly improve the security and integrity of the system, allow for cost effective real time access to the information required from each safe and allow real time setup, programming or reprogramming of the electronic safe or its bill acceptor as required. These improved capabilities can be provided to those making day to day use and operation of the system.

In accordance with another aspect of the present invention, by providing the appropriate interface from the bill acceptor to the controller with access through either a serial port, IRDA port, or other wireless port, an authorized manager can update the bill acceptor with new firmware to allow new or improved currency to be accepted, new or improved anti-counterfeiting techniques to be incorporated, or any changes required within the safe controller to be updated without the need to open the safe or have access to the currency. Techniques for uploading program memory through wired connections are well known in the art. Further details of presently preferred optical update techniques are described in U.S. patent application Ser. No. 09/448,067, assigned to the assignee of the present invention and entitled “Methods and Apparatus for Optical Communication Update of Program Memory in Embedded Systems”, which is herein incorporated by reference in its entirety. The use of wireless updates, including Blue Tooth™ based techniques, for example, may be particularly suitable when used in conjunction with a local area network as addressed further herein.

Current electronic safes have the ability to generate a large number of reports including collection reports, shift reports, daily reports, “z” reports based on business day rather than calendar day, cashier reports and the like. With the exception of collection reports, all the other reports are generated at the initiation of the authorized person. The collection reports are typically automatically generated when the safe door is opened or when the cassette is removed from the safe. The generation of the various reports are selected by the authorized person and generated at his or her request at the time of the request, causing problems when the responsible person is not on site when the reports are expected to be run, or if the responsible person forgets to run the report or is otherwise detained and cannot run the report on time.

An electronic safe system in accordance with the present invention eliminates the problems of prior art systems, by allowing an auto-report mode of operation. In this mode, the reporting time and date range, frequency of reports, and authority to generate the report is programmed into the electronic safe system. The reports will be generated and saved at the appropriate times. Only the actual printing of the reports will require the input of the authorized person and this printing may be performed at any time. The report will reflect the correct time, date and data content associated with the range of time and date reported. In this mode, the reporting serves the business, rather than drives the business.

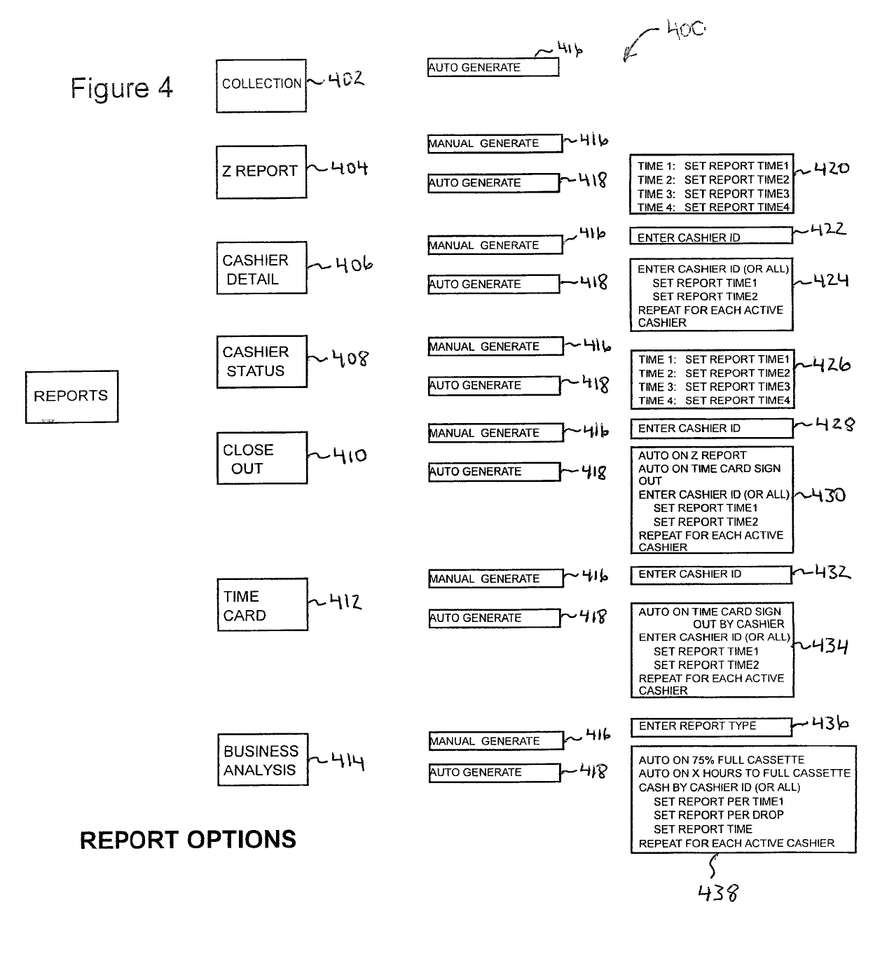

FIG. 4 illustrates various reporting options 400 in accordance with the present invention. As described above, collection reports 402 are typically automatically generated when deposits are collected from the electronic safe. Z reports 404, cashier detail reports 406, cashier status reports 408, close out reports 410, time card reports 412 and business analysis reports 414 may be created utilizing a manual generate option 416 or an automatic generate option 418. Z reports 404 may be automatically generated at predetermined times as shown in block 420. Cashier detail reports 406 may be manually generated by entering a cashier ID as shown in block 422, or automatically generated at predetermined times as shown in block 424. Cashier status reports 408 may be manually generated, or automatically generated at predetermined times as shown in block 426. Close out reports 410 may be manually generated by entering a cashier ID as shown in block 428, or automatically generated at predetermined times or when particular events occur as shown in block 430. Time card reports 412 may be manually generated by entering a cashier ID as shown in block 432, or automatically generated at predetermined times or when particular events occur as shown in block 434. Business analysis reports 414 may be manually generated by entering a report type as shown in block 436, or automatically generated at predetermined times or when particular events occur as shown in block 438.

As an example, as described below, an electronic safe in accordance with the present invention may track the time cashiers begin and quit working during a shift. When a cashier arrives at work, the cashier will sign in to the electronic safe or in some other fashion communicate to the electronic safe that the cashier has begun working. When a cashier departs work, the electronic safe will record the departure time. At set reporting times, the electronic safe may automatically generate a time card report 412 detailing the hours worked by the cashiers or other employees. Alternatively, an employee, such as a manager, may cause the electronic safe to manually generate a time card report 412 detailing the work schedule of one or more cashiers.

As discussed above, prior art safes depend on a routine collection program and are designed to allow sufficient bills to be stored to accommodate the typical pickup schedules. In fact, as the current electronic safes are not qualified as security devices, they are typically referred to as temporary storage devices not intended to be left unattended or for long periods of time before being collected. This is normally not a problem, since bank deposits or armored pickups are done on a daily basis. However, there are significant dollar amounts associated with the routine of daily deposits whether or not an armored service is used. In an attended site, the knowledge of when a pickup or bank deposit must be made can save considerable expense. An electronic safe system in accordance with the present invention provides the capability to predict the time and day the cassette will be full and require replacement. There are a number of methods that can be used to make these predictions. One such technique would track and keep a running histogram of bills per hour or shift for each day of the week and predict based on the deviation of the norm from its saved data. The method can be used by each electronic safe based on its own use pattern, thereby providing an optimum prediction every time. As would be understood by one skilled in the art, advanced methods using neural networks can also be used in accordance with the teachings of the present invention.

Insofar as the data for each cashier, bill or check accepted is stored in the electronic safe for a period of time, a feature of the present invention is to provide analysis of the data which will allow the manager to optimize the operation of the business. The information resulting from the analysis includes but is not limited to the following. An electronic safe system in accordance with the present invention may suitably report on the amount of money by hour, by shift, day of the week, or the like to allow optimizing of cashier hiring. The electronic safe can report on the average drops per cashier over similar periods of time to determine if the work level is being maintained or if business is being lost and should be investigated by the manager. The electronic safe can report the average cash per drop per shift, per day, and the like to help determine the nature of the safe's usage over these same time periods. The average cash per drop for different cashiers on the same shift might point to incorrect use of the safe. Many retailers require all $50 and $100 bills be dropped directly and immediately into the electronic safe, bypassing the POS terminal. Such reporting can alert the manager that these rules are not being followed.

Currently, an alternate apparatus for tracking the employee's time has to be used even when an electronic safe is also used. An electronic safe system in accordance with the present invention has the ability to have each employee enter through the keypad, optically or utilizing an ID tag, such as bracelet 130 of FIG. 1, their identification number or name. In accordance with the present invention, they will enter this when they arrive and when they leave. The electronic safe will then track the time worked by each employee and generate daily, weekly or any regularly scheduled report of time worked. This information can also be uploaded to a host computer for generating the appropriate pay information.

It will be apparent to those skilled in the art that various modifications and variations can be made in the present invention without departing from the spirit and scope of he present invention. Thus, it is intended that the present invention covers the modifications and variations of this invention provided they come within the scope of the appended claims and their equivalents.

We claim:

1. An electronic safe for accepting both cash and non-cash deposits comprising:
a bill acceptor for accepting both the cash deposits and the non-cash deposits;
a controller for controlling the operation of the bill acceptor, and for receiving an indication of the value of the non-cash deposits; and
a cassette for storing both the cash deposits and the non-cash deposits.

2. The electronic safe of claim 1 further comprising a data entry apparatus for entering the value of the non-cash deposits, and wherein the data entry apparatus transmits the indication of the value of the non-cash deposits to the controller.

3. The electronic safe of claim 1 wherein the indication of the value of the non-cash deposits is transmitted from a point of sale terminal.

4. The electronic safe of claim 1 wherein the indication identifies the type of the non-cash deposit.

5. The electronic safe of claim 1 wherein the non-cash deposit comprises an envelope.

6. The electronic safe of claim 5 wherein the envelope contains a check.

7. The electronic safe of claim 5 wherein the envelope contains a currency note which cannot be accepted as a cash deposit.

8. The electronic safe of claim 5 wherein the envelope identifies the type of non-cash deposit.

9. The electronic safe of claim 5 wherein the envelope identifies the amount of the non-cash deposit.

10. The electronic safe of claim 1 wherein the bill acceptor is further for accepting an identifying tag.

11. The electronic safe of claim 10 wherein the identifying tag identifies the value of the non-cash deposit.

12. The electronic safe of claim 10 wherein the identifying tag identifies the type of non-cash deposit.

13. The electronic safe of claim 1 wherein the non-cash deposit comprises a printed identification slip which identifies a change in a cashier managed event.

14. An electronic safe comprising:
means for accepting and storing deposits;
means for communicating with an identification tag, said identification tag identifying a person interacting with the electronic safe.

15. The electronic safe of claim 14 wherein the identification tag identifies the person interacting with electronic safe as someone making a deposit into the safe, withdrawing cash from the safe, or requesting a report to be generated by the safe.

16. The electronic safe of claim 14 wherein the identification tag is for wearing around the wrist of the person placing deposits.

17. The electronic safe of claim 14 wherein the means for communicating periodically transmits a polling signal to determine the presence of the identification tag.

18. The electronic safe of claim 14 wherein the means for communicating includes a transmitter, and power for the identification tag is supplied from the transmitter.

19. The electronic safe of claim 14 wherein the identification tag functions as an electronic key.

20. The electronic safe of claim 14 wherein the means for communicating utilizes radio frequency (RF) technology to communicate with the identification tag.

21. An electronic safe comprising:
means for accepting and storing deposits; and
means for communicating with a wireless portable device, said wireless portable device for configuring the safe.

22. The electronic safe of claim 21 wherein the means for communicating utilizes infrared communication to communicate with the wireless portable device.

23. The electronic safe of claim 21 wherein the portable device is for causing the electronic safe to generate reports.

24. The electronic safe of claim 21 wherein the portable device is for updating operating code of the electronic safe.

25. The electronic safe of claim 24 wherein the portable device is further for initiating the printing of the automatically generated reports.

26. An electronic safe system comprising:
a plurality of electronic safes; and
a wireless network connecting said plurality of safes.

27. The electronic safe system of claim 26 further comprising:
a communications node for providing wireless communications to an off site host system.

28. The electronic safe system of claim 27 wherein the off site host system remotely monitors the plurality of electronic safes.

29. The electronic safe system of claim 27 wherein the communications node comprises a wireless modem.

30. The electronic safe system of claim 26 wherein the wireless network connects the plurality of safes to an external network.

31. An electronic safe comprising:
means for accepting deposits;
a cassette for storing the deposits; and
means for predicting when the cassette will be full of deposits.

32. An electronic safe comprising:
means for accepting deposits;
means for storing deposits; and
means for automatically generating and storing reports detailing the operation of the electronic safe during a predetermined period.

33. The electronic safe of claim 32 further comprising means for printing the stored reports when instructed by an authorized person.

34. The electronic safe of claim 32 wherein the reports include the amount of deposits per shift.

35. The electronic safe of claim 32 wherein the reports include the amount of deposits per cashier over a predetermined period of time.

36. An electronic safe comprising:
means for accepting deposits;
means for storing deposits;
a controller for controlling the operation of the safe, said controller for tracking the number of hours worked by an employee.

37. The electronic safe of claim 36 wherein the employee provides an indication to the electronic safe when the employee arrives at work and when the employee leaves work.

38. The electronic safe of claim 37 wherein the employee provides the indication by entering an identification number on an input device of the electronic safe.

39. The electronic safe of claim 36 wherein the controller tracks the number of hours worked by the employee by detecting an identification tag attached to the employee.

40. The electronic safe of claim 36 further comprising means for generating periodic reports of the number of hours worked.

41. A method of operating an electronic safe for accepting both cash and non-cash deposits, said electronic safe comprising a bill acceptor for accepting both the cash deposits and the non-cash deposits, a controller for controlling the operation of the bill acceptor and receiving an indication of the value of the non-cash deposits, and a cassette for storing both the cash deposits and the non-cash deposits, the method comprising the steps of:
placing a non-cash deposit into an envelope;
placing the envelope into the bill acceptor; and
storing the envelope in the cassette.

42. The method of claim 41 wherein the electronic safe further comprises a data entry apparatus for entering the value of the non-cash deposits, the method further comprising the step of:
transmitting an indication of the value of the non-cash deposits to the controller by the data entry apparatus.

43. The method of claim 41 further comprising the step of:
transmitting from a point of sale terminal the value of the non-cash deposit.

44. The method of claim 41 further comprising the step of:
communicating to the electronic safe the type of the non-cash deposit.

45. The method of claim 44 further comprising the step of:
transmitting from a point of sale terminal the type of the non-cash deposit.

46. The method of claim 41 wherein the envelope contains a check.

47. The method of claim 41 wherein the envelope contains a currency note which cannot be accepted as a cash deposit.

48. The method of claim 41 wherein the envelope identifies the type of non-cash deposit.

49. The method of claim 41 wherein the envelope identifies the amount of the non-cash deposit.

50. The method of claim 41 further comprising the step of:
inserting an identifying tag in the bill acceptor, the identifying tag identifying the type of the non-cash deposit.

51. The method of claim 50 wherein the identifying tag identifies the value of the non-cash deposit.

52. The method of claim 50 wherein the identifying tag identifies the type of non-cash deposit.

53. A method of operating an electronic safe, the electronic safe comprising apparatus for accepting and storing deposits, and apparatus for communicating with an identification tag, said identification tag identifying a person interacting with the electronic safe, the method comprising the steps of:
attaching the identification tag to a person;
interacting with the electronic safe by the person;
identifying, by the electronic safe, the identity of the person interacting with the electronic safe by detecting the identification tag; and
recording and storing the identity of the person interacting with the electronic safe.

54. The method of claim 53 wherein the identification tag identifies the person interacting with electronic safe as someone making a deposit into the safe, withdrawing cash from the safe, or requesting a report to be generated by the safe.

55. The method of claim 53 wherein the identification tag is worn around the wrist of the person interacting with the electronic safe.

56. The method of claim 53 further comprising the step of:
transmitting a polling signal to determine the presence of the identification tag.

57. The method of claim 53 wherein the means for communicating includes a radio frequency (RF) transmitter, and power for the identification tag is supplied from the transmitter.

58. The method of claim 53 wherein the identification tag functions as an electronic key.

59. A method of operating an electronic safe, the electronic safe comprising apparatus for accepting and storing deposits, and apparatus for communicating with a wireless portable device:
transmitting a message from the wireless portable device to the electronic safe;
receiving the message by the electronic safe; and
perform an action in response to the message by the electronic safe.

60. The method of claim 59 further comprising the step of:
transmitting configuration information from the wireless portable device to the electronic safe.

61. The method of claim 59 wherein the electronic safe utilizes infrared communication to communicate with the wireless portable device.

62. The method of claim 59 wherein the transmitted message causes the electronic safe to generate reports.

63. The method of claim 59 further comprising the step of:
transmitting updated operating code to the electronic safe by the wireless portable device.

64. A method of operating an electronic safe, the electronic safe comprising apparatus for accepting deposits, a cassette for storing the deposits, and a controller for controlling the operation of the electronic safe, the method comprising the steps of:
monitoring the rate of deposits made to the electronic safe; and
predicting when the cassette will be full of deposits.

65. The method of claim 64 further comprising the step of:
communicating a message indicating when the electronic safe will be full.

66. A method of operating an electronic safe, the electronic safe comprising apparatus for accepting deposits, a cassette for storing the deposits, and a controller for controlling the operation of the electronic safe, the method comprising the steps of:
monitoring the operation of the electronic safe by the controller; and
automatically generating and storing reports detailing the operation of the electronic safe.

67. The method of claim 66 further comprising the step of:
printing the stored reports when instructed by an authorized person.

68. The method of claim 67 wherein the reports include the amount of deposits per shift.

69. The method of claim 67 wherein the reports include the amount of deposits per cashier over a predetermined period of time.

70. A method of tracking employee hours worked by an electronic safe, the electronic safe comprising apparatus for accepting and storing deposits, and a controller for controlling the operation of the safe, the method comprising the steps of:
receiving an indication when an employee begins work;
receiving an indication when the employee stops work; and
tracking the number of hours worked by an employee.

71. The method of claim 70 wherein the employee provides the indication by entering an identification number on an input device of the electronic safe.

72. The method of claim 70 wherein the controller tracks the number of hours worked by the employee by detecting an identification tag attached to the employee.

73. The method of claim 70 further comprising the step of:
generating periodic reports of the number of hours worked.
